(19) United States
(12) Patent Application Publication
(10) Pub. No.: US 2026/0194979 A1
(43) Pub. Date: Jul. 9, 2026

(54) SYSTEMS AND METHODS FOR PROVIDING REAL-TIME FEEDBACK VIA GRAPHICAL USER INTERFACE ELEMENTS

(71) Applicant: GOOGLE LLC, Mountain View, CA (US)

(72) Inventors: Karan Gupta, New Delhi (IN); Ramprasad Sedouram, Bangalore (IN)

(21) Appl. No.: 19/011,945

(22) Filed: Jan. 7, 2025

(51) Int. Cl. G06F 3/01; G06F 3/0481; G06Q 20/32

(52) U.S. Cl. CPC G06F 3/016; G06F 3/0481; G06Q 20/322; G06F 2203/014

(57) ABSTRACT

Systems and methods for providing real-time feedback via a graphical user interface are provided. Example techniques may include providing, by a user device, a user interface including a graphical display associated with a transaction, wherein the graphical display includes: (i) an interactive slider element configured to visually represent completing the transaction based on a user action including an interaction with the interactive slider element and (ii) one or more additional elements configured to provide additional user feedback based on the user action; detecting, by the user device, an initiation of the user action with respect to the slider element and the one or more additional elements of the graphical display; and providing, by the user device, prior to completion of the user action, real-time feedback via the slider element and the one or more additional elements in response to the initiation of the user action of the graphical display.

### FIELD OF THE INVENTION

The present disclosure generally relates to technologies associated with interactive graphical user interfaces, and more particularly, to technologies for providing real-time feedback via one or more elements of a graphical user interface for safer, more informed transactions.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Touch screen technology has revolutionized the way individuals interact with digital devices. In addition to the traditional tap gesture, touch screens now support a wide range of other gestures, such as prolonged press, force tap, swipe, pinch, and zoom. These gestures have opened new possibilities for user interaction and have made it easier and more intuitive to perform various tasks on touch screen devices. Click-to-action buttons have also evolved to many formats in digital interfaces, one of which is slider buttons. Slider buttons are often used in digital interfaces to provide users with more control over their input. For instance, users can slide their finger to a specific point on the slider, rather than simply tapping on the button.

However, conventional “tap” gestures or conventional single “slide” gestures, though straightforward and quick to operate, are vulnerable to errors. This problem is amplified in important transactions such as making payments or sending important documents, where a single “confirm” “continue pay” button or a conventional single slider is not only prone to unintended user errors, but also inadequate to effectively draw the user's attention or provide the user an opportunity to notice or fix any errors before completing the transaction. For example, if a user enters an incorrect amount of money before sending a payment, a single “confirm” button or a conventional single slider, which calls for a quick tap or slide, is unlikely to provide an opportunity for the user to notice the error or an opportunity to fix the error before completing the transaction.

### SUMMARY

In one aspect, a computer-implemented method for providing real-time feedback via one or more elements of a graphical user interface for safer, more informed transactions is provided. The method may include providing, by a user device, a user interface including a graphical display associated with a transaction, wherein the graphical display includes: (i) an interactive slider element configured to visually represent completing the transaction based on a user action including an interaction with the interactive slider element and (ii) one or more additional elements configured to provide additional user feedback based on the user action; detecting, by the user device, an initiation of the user action with respect to the slider element and the one or more additional elements of the graphical display; and providing, by the user device, prior to completion of the user action, real-time feedback via the slider element and the one or more additional elements in response to the initiation of the user action of the graphical display. The method may include additional, less, or alternate actions, including those discussed elsewhere herein.

In another aspect, a computer system for providing real-time feedback via one or more elements of a graphical user interface for safer, more informed transactions is provided. The computer system may include one or more processors of a user interface and at least one memory storing processor-executable instructions that, when executed by the one or more processors, cause the one or more processors to: perform operations comprising: providing, a user interface including a graphical display associated with a transaction, wherein the graphical display includes: (i) an interactive slider element configured to visually represent completing the transaction based on a user action including an interaction with the interactive slider element and (ii) one or more additional elements configured to provide additional user feedback based on the user action; detecting, an initiation of the user action with respect to the slider element and the one or more additional elements of the graphical display; and providing, prior to the completion of the user action, real-time feedback via the slider element and the one or more additional elements in response to the initiation of the user action of the graphical display. The system may include additional, less, or alternate functionality, including that discussed elsewhere herein.

In still another aspect, a non-transitory computer-readable storage medium storing processor-readable instructions for providing real-time feedback via one or more elements of a graphical user interface for safer, more informed transactions is provided. The computer-readable instructions, when executed by one or more processors of a user device, cause the one or more processors to: perform operations comprising: providing, a user interface including a graphical display associated with a transaction, wherein the graphical display includes: (i) an interactive slider element configured to visually represent completing the transaction based on a user action including an interaction with the interactive slider element and (ii) one or more additional elements configured to provide additional user feedback based on the user action; detecting, an initiation of the user action with respect to the slider element and the one or more additional elements of the graphical display; and providing, prior to the completion of the user action, real-time feedback via the slider element and the one or more additional elements in response to the initiation of the user action of the graphical display. The instructions may direct additional, less, or alternative functionality, including that discussed elsewhere herein.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1 illustrates a block diagram of an exemplary computer system that implements techniques of this disclosure for providing real-time feedback via one or more elements of a graphical user interface for safer, more informed transactions, according to one embodiment.

FIG. 2 illustrates a flow diagram of an exemplary computer-implemented method for providing real-time feedback via one or more elements of a graphical user interface for safer, more informed transactions, according to one embodiment.

FIG. 3 illustrates an example conventional single slider.

FIG. 4 illustrates an exemplary graphical user interface for providing real-time feedback via one or more elements of a graphical user interface for safer, more informed transactions, where the one or more elements may include a spinner element.

FIG. 5 illustrates two exemplary graphical user interfaces for providing real-time feedback via one or more elements of a graphical user interface for safer, more informed transactions, where the one or more elements may include circles whose sizes correspond to sizes of payment amounts.

FIG. 6 illustrates exemplary slider elements in geometric shapes with numbers of sides corresponding to payment terms or payment amounts.

FIG. 7 illustrates an exemplary graphical user interface for providing real-time feedback via one or more elements of a graphical user interface for safer, more informed transactions, where the real-time feedback may include haptic feedback in frequencies corresponding to currency multiples.

FIG. 8 illustrates an exemplary graphical user interface for providing real-time feedback via one or more elements of a graphical user interface for safer, more informed transactions, where the real-time feedback may include haptic feedback which alerts a user of a risky recipient.

FIG. 9 illustrates two exemplary graphical user interfaces for providing real-time feedback via one or more elements of a graphical user interface for safer, more informed transactions, where the one or more elements may include distinctive colors or icons which represent successful or failed transactions.

FIG. 10 illustrates two exemplary graphical user interfaces for providing real-time feedback via one or more elements of a graphical user interface for safer, more informed transactions, where the one or more elements may include distinctive colors or specific placement of icons which represent whether an unsuccessful completion of the transaction is related to an issue associated with a sender or related to an issue associated with a recipient.

FIG. 11 illustrates an exemplary graphical user interface for providing real-time feedback via one or more elements of a graphical user interface for safer, more informed transactions, where the one or more elements may include one or more circles configured to proportionally represent different amounts corresponding to different recipients of a bulk payment.

FIG. 12 illustrates an exemplary graphical user interface for providing real-time feedback via one or more elements of a graphical user interface for safer, more informed transactions, where the one or more elements may include one or more bar shapes with fillings configured to proportionally represent different amounts corresponding to different recipients of a bulk payment.

FIG. 13 illustrates an exemplary graphical user interface for providing real-time feedback via one or more elements of a graphical user interface for safer, more informed transactions, where the one or more elements may include one or more interactive elements configured to visually represent additional users for delegated payments.

FIG. 14 illustrates an exemplary graphical user interface for providing real-time feedback via one or more elements of a graphical user interface for safer, more informed transactions, where the one or more elements may include an interactive display element configured to visually display one or more payment methods.

FIG. 15 illustrates an exemplary graphical user interface for providing real-time feedback via one or more elements of a graphical user interface for safer, more informed transactions, where the one or more elements may include shapes proportional to fund balances of one or more payment methods.

FIG. 16 illustrates an exemplary graphical user interface for providing real-time feedback via one or more elements of a graphical user interface for safer, more informed transactions, where the one or more elements may include an interactive display element configured to visually display one or more currency denominations with increasing or reducing options.

FIG. 17 illustrates an exemplary graphical user interface for providing real-time feedback via one or more elements of a graphical user interface for safer, more informed transactions, where the one or more elements may include an interactive element configured to authenticate a user's identity before completing the transaction.

FIG. 18 illustrates an exemplary graphical user interface for providing real-time feedback via one or more elements of a graphical user interface for safer, more informed transactions, where the one or more elements may include one or more interactive elements configured to visually represent fractions of a payment total.

FIG. 19 illustrates an exemplary graphical user interface for providing real-time feedback via one or more elements of a graphical user interface for safer, more informed transactions, where the one or more elements may include an interactive element configured to visually represent various options of a tip amount as a part of the transaction.

FIG. 20 illustrates an exemplary graphical user interface for providing real-time feedback via one or more elements of a graphical user interface for safer, more informed transactions, where the one or more elements may include an interactive element configured to visually represent a voice recording function.

While the systems and methods disclosed herein is susceptible of being embodied in many different forms, it is shown in the drawings and will be described herein in detail specific exemplary embodiments thereof, with the understanding that the present disclosure is to be considered as an exemplification of the principles of the systems and methods disclosed herein and is not intended to limit the systems and methods disclosed herein to the specific embodiments illustrated. In this respect, before explaining at least one embodiment consistent with the present systems and methods disclosed herein in detail, it is to be understood that the systems and methods disclosed herein is not limited in its application to the details of construction and to the arrangements of components set forth above and below, illustrated in the drawings, or as described in the examples.

Methods and apparatuses consistent with the systems and methods disclosed herein are capable of other embodiments and of being practiced and carried out in various ways. Also, it is to be understood that the phraseology and terminology employed herein, as well as the abstract included below, are for the purposes of description and should not be regarded as limiting.

### DETAILED DESCRIPTION

### Overview

As discussed above, conventional tapping or slider elements of touch screens on user devices are typically designed for generic single “tap” or “slide” gestures, which, despite being quick to operate, are vulnerable to errors, especially for important transactions where a conventional “single-swipe-on-button” or “tap-on-button” is inadequate to effectively draw the user's attention or provide the user an opportunity to notice or fix any errors before completing the transaction.

The techniques of this disclosure aim to achieve a novel interaction paradigm that performs transactions conveniently but makes the transactions safer and more informed via a graphical user interface with real-time feedback.

The present disclosure relates to techniques for providing real-time feedback via one or more elements of the interactive graphical user interface before transactions are completed to achieve safer, more informed transactions. In particular, in addition to a conventional slider, the graphical interface may include one or more additional elements, and the user may interact with both the slider and the additional elements in a single user action before the transaction is completed. The graphical interface may also respond with real-time feedback after the initiation of the user action but before the completion of the transaction to provide more information about the transaction and allow the user to complete more complicated transactions in a better-informed way. This way, the user action is a convenient single action but may still effectively draw the user's attention and provide the user an opportunity to notice or fix any errors before completing the transaction. For instance, in some examples, the user interface may provide haptic feedback before the completion of a payment transaction to warn the user of a risky recipient. This haptic feedback may draw the user's attention and provide the user with an opportunity to stop the transaction before completion. Moreover, in some examples, the interface may display geometric shapes in various sizes proportional to a payment amount to better inform the user of the payment amount. Furthermore, in some examples, the interface may be configured to control the speed at which a sliding element can be moved such that the movement speed of the sliding element is inversely proportional to the payment amount and requires more user effort to complete a transaction with a larger payment amount, which may draw more attention of the user. In addition to payment transactions, the techniques of this disclosure can also apply to other scenarios, for example, sending files to other recipients, making recordings, or uploading files. Advantageously, the interaction techniques provided herein reduce the risk of errors by allowing users to confirm their actions before completing the transaction. The interaction techniques provided herein also offer greater control and improved flexibility, and may allow users to customize their interactions based on their preferences.

### Example System

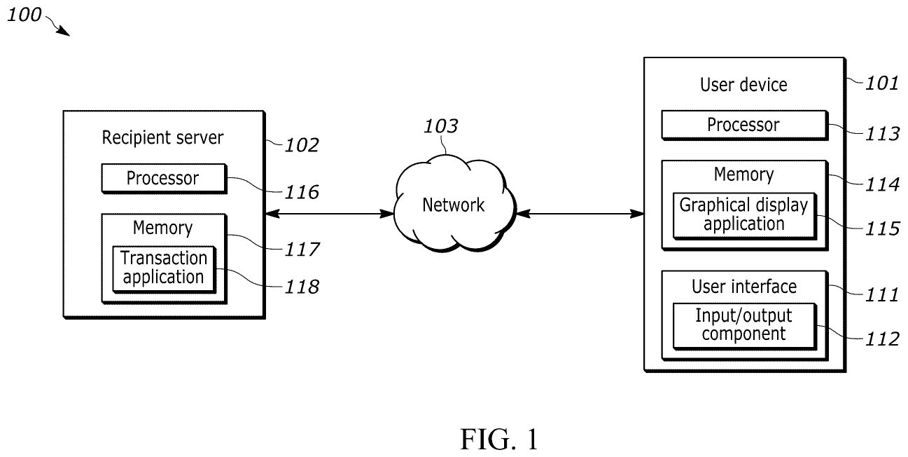

Referring now to the drawings, FIG. 1 illustrates an exemplary computer system 100 for providing real-time feedback via one or more elements of a graphical user interface for safer, more informed transactions, according to one embodiment. The high-level architecture illustrated in FIG. 1 may include both hardware and software applications, as well as various data communications channels for communicating data between the various hardware and software components, as is described below.

The system 100 may include one or more mobile user computing devices 101, as well as a recipient server 102. Each of the user computing devices 101 or recipient server 102 may include, e.g., smart phones, smart watches or fitness tracker devices, tablets, laptops, virtual reality headsets, smart or augmented reality glasses, wearables, other personal computer, etc. The recipient server 102, and user computing device(s) 101 may be configured to communicate with one another via a wired or wireless computer network 103.

Although one recipient server 102, one user computing device 101, and one network 103 are shown in FIG. 1, any number of such recipient server 102, user devices 101, and networks 103 may be included in various embodiments. To facilitate such communications the recipient server 102 and user computing device(s) 101 may each respectively comprise a wireless transceiver to receive and transmit wireless communications.

The user computing device(s) 101 may include, or may be configured to communicate with, a user interface 111, which may receive input from users and may provide audible or visible output to users via one or more input/output component 112.

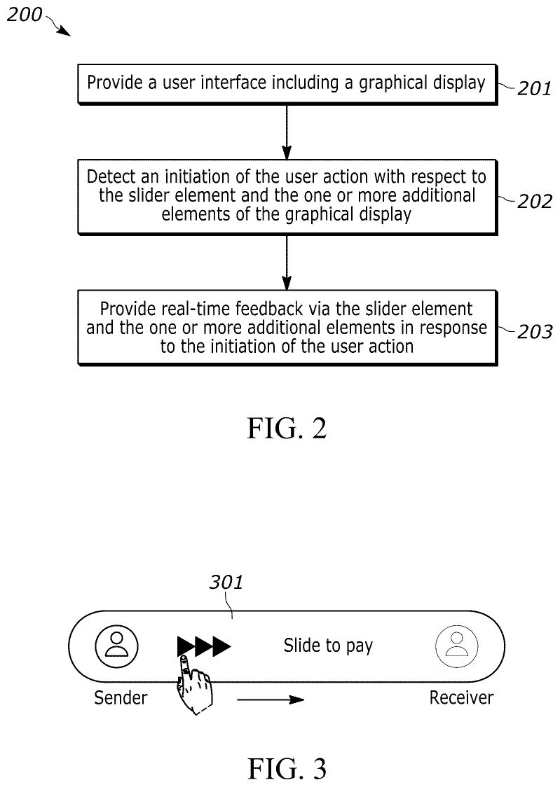

Additionally, the user computing device(s) 101 may include one or more processor(s) 113, as well as one or more computer memories 114. Memorie(s) 114 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memorie(s) 114 may store an operating system (OS) (e.g., iOS, Microsoft Windows, Linux, UNIX, etc.) capable of facilitating the functionalities, apps, methods, or other software as discussed herein. The memorie(s) 114 may be accessible by the one or more processors 113 (e.g., via a memory controller). The one or more processors 113 may interact with the memorie(s) 114 to obtain, for example, computer-readable instructions stored in the memorie(s) 114. The computer-readable instructions stored in memorie(s) 114 may cause the one or more processors 113 to execute one or more applications, including a graphical display application 115. Furthermore, in some examples, the computer-readable instructions stored on the memorie(s) 114 may include instructions for carrying out any of the steps of the method 200, described in greater detail below with respect to FIG. 2.

Executing the graphical display application 115 may include, in some examples, providing graphical display and graphical elements associated with a transaction (e.g., including any of the graphical displays illustrated below at FIGS. 3-20), receiving user input including interactions with the graphical display and graphical elements via the input/output component 112, and providing feedback in response to the user input, sending confirmation of the transaction, payment transaction amount, and any other information associated with the transaction to other user devices or to the recipient server 102. In some examples, executing the graphical display application 115 may include sending a file to be transferred to the other user devices through the recipient server 102. Executing the graphical display application 115 may further include, in some examples, providing user access to transactions via the graphical display application 115 based on the user signing in to the graphical display application 115, or otherwise providing login credentials or other user identifying information to the graphical display application 115, which may in turn provide the login credentials or other user identifying information to the recipient server 102. Moreover, in some examples, executing the graphical display application 115 may include providing additional information to the recipient server 102, such as, for instance, an indication of delegation or other authorization via the graphical display application 115.

In some embodiments the recipient server 102 may comprise one or more servers, which may comprise multiple, redundant, or replicated servers as part of a server farm. In still further aspects, such server(s) may be implemented as cloud-based servers, such as a cloud-based computing platform. For example, such server(s) may be any one or more cloud-based platform(s) such as MICROSOFT AZURE, AMAZON AWS, or the like. Such server(s) may include one or more processor(s) 116 (e.g., CPUs) as well as one or more computer memories 117.

Memorie(s) 117 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memorie(s) 117 may store an operating system (OS) (e.g., Microsoft Windows, Linux, UNIX, etc.) capable of facilitating the functionalities, apps, methods, or other software as discussed herein. Memorie(s) 117 may also store a transaction application 118. Executing the transaction application 118 may include, in some examples, receiving a confirmation of a transaction, or other data or files related to the transaction, from the user device 101, and, in some examples, sending the confirmation of the transaction or other data or files related to the transaction to other devices, including devices associated with other users. For instance, in some examples, the server 102 may be associated with a bank, and may access a user's bank account in order to make payments to other entities or other users based on receiving a confirmation of a transaction from the user device 101.

### Example Method

FIG. 2 depicts a flow diagram of an exemplary computer-implemented method 200 as may be implemented by the system 100 of FIG. 1, for providing real-time feedback via one or more elements of a graphical user interface for safer, more informed transactions, according to one embodiment. One or more steps of the method 200 may be implemented as a set of instructions stored on a computer-readable memory (e.g., memory 114) and executable on one or more processors (e.g., processor 113).

The method 200, at block 201, may include providing, by a user device (e.g., the user computing device 101), a user interface (e.g., the user interface 111) including a graphical display (e.g., as on the graphical display application 115) associated with a transaction. The graphical display may include an interactive slider element configured to visually represent completing the transaction based on a user action and one or more additional elements configured to provide additional user feedback based on the user action. The user action may include an interaction with the interactive slider element.

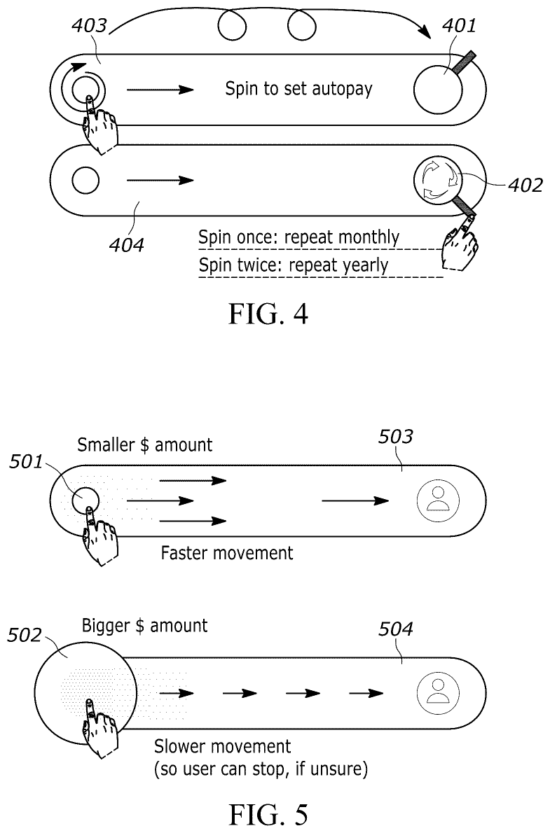

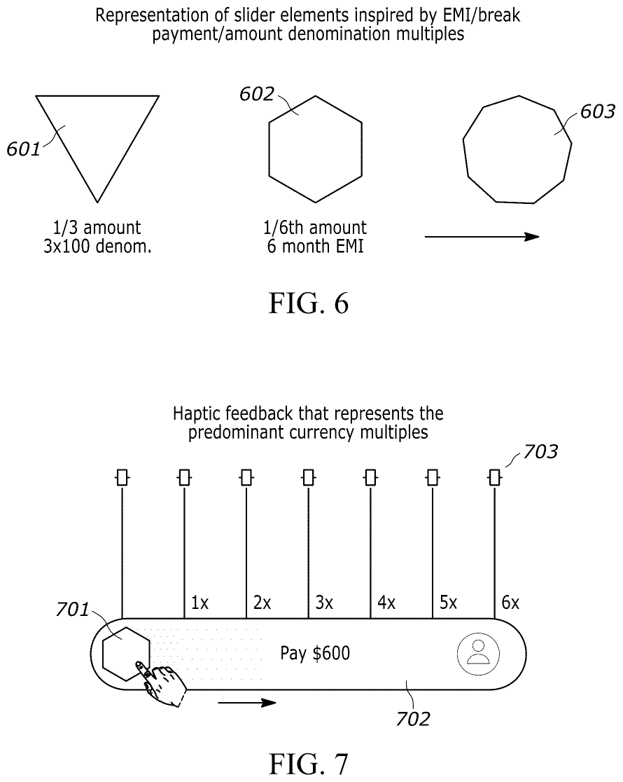

In some examples, the transaction may be a file transfer. Moreover, in some examples, the transaction may be a payment. For instance, in some examples where the transaction is a payment, the one or more additional elements may include a second interactive element configured to visually represent a spinner element, which may be configured to receive user input including spins at different repetitions. For instance, the repetitions of the spins may correspond to frequencies at which a same transaction will be repeated automatically, as illustrated in FIG. 4 and discussed below. Further, in some examples where the transaction is a payment, the one or more additional elements may include a geometric shape with number of sides corresponding to currency denomination multiples, as illustrated in FIGS. 6 and 7 and discussed below.

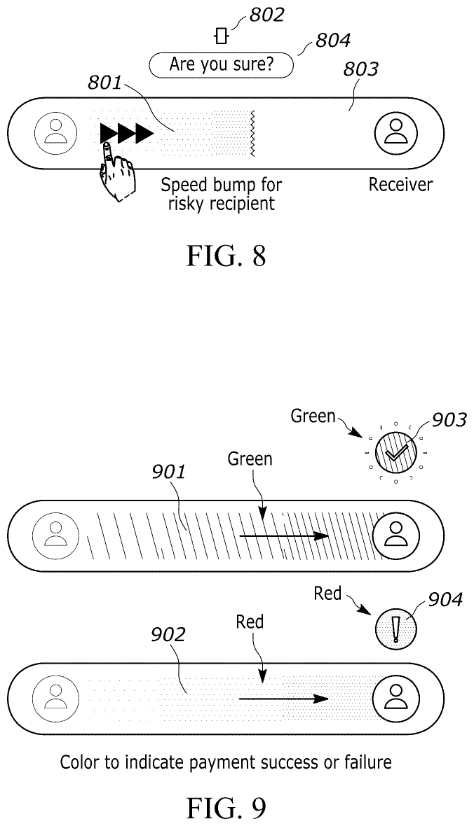

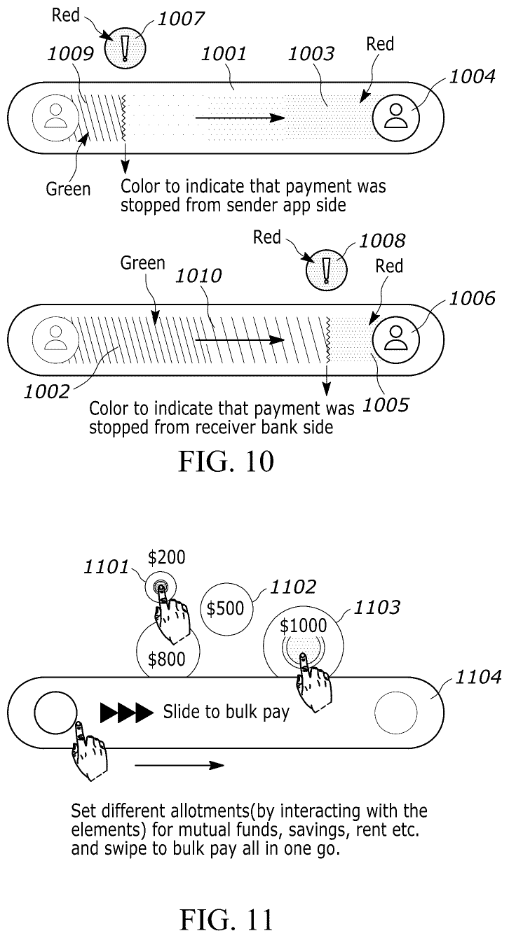

Additionally, where the transaction is a payment, the one or more additional elements may include one or more distinctive colors to indicate a status of the transaction, where the status may include a risky status of a receiver as illustrated in FIG. 8, a failed transaction as illustrated in FIGS. 9 and 10, or an indication of fund balance as illustrated in FIG. 15. Further, in some examples where the transaction is a payment, the one or more additional elements may include a circle where a size of the circle corresponds to a payment amount where a bigger circle represents higher payment amount as illustrated in FIG. 5. The circle size (and payment amount) may further correspond to a movement speed of the circle. For instance, for a first (smaller) payment amount, a particular user action may result in a first (faster) movement speed of the circle, and for a second (greater) payment amount, the same user action may result in a second (slower) movement speed of the circle.

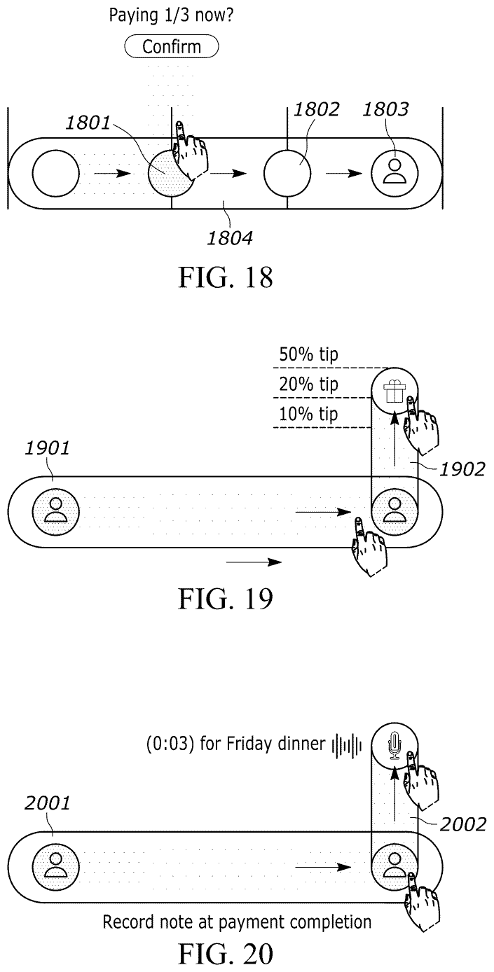

Moreover, in some examples where the transaction is a payment, the one or more additional elements may include one or more interactive elements configured to visually represent fractions of a payment total, as illustrated in FIG. 18 and discussed below. Further, in some examples where the transaction is a payment, the one or more additional elements may include a second interactive element configured to visually represent various options of a tip amount as a part of the transaction, as illustrated in FIG. 19 and discussed below. Additionally, in some examples, the one or more additional elements may include a second interactive element configured to visually represent a voice recording function. The voice recording function may be configured to receive and store user voice input corresponding to a voice memo associated with the transaction, as illustrated in FIG. 20 and discussed below.

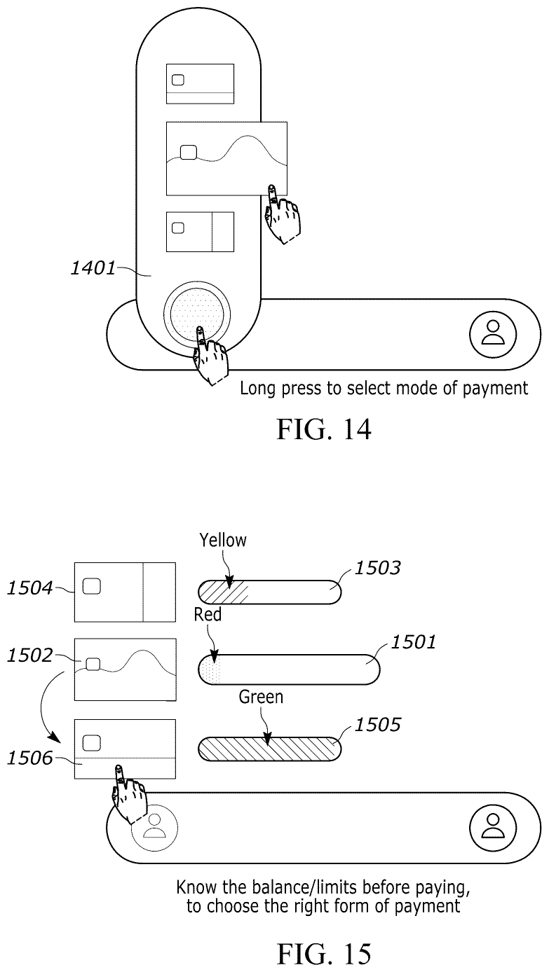

Further, in some examples where the transaction is a payment, the one or more additional elements may include an interactive display element configured to visually display one or more currency denominations with increasing or reducing options. For instance, the display element may be configured to receive user input indicating a currency denomination selected by a user to increase or reduce a total payment amount, as illustrated in FIG. 11 and discussed below. Moreover, in some examples where the transaction is a payment, the one or more additional elements may include an interactive display element configured to visually display one or more payment methods and to receive user input indicating a payment option selected by a user before completing the transaction. For instance, the display element may include first portion having a first shape and a second portion having a second shape, and the shape of the first portion relative to the shape of the second portion visually may represent a fund balance of a first payment method relative to a second payment method, as illustrated in FIGS. 14 and 15 and discussed below.

Additionally, in some examples in the one or more additional elements may include corresponding icons. For instance, a first icon may represent a successful completion of the transaction, and a second icon may represent a failed completion of the transaction, as illustrated in FIGS. 9 and 19 and discussed below. Further, in some examples where the one or more additional elements include the aforementioned corresponding icons, a placement of an icon in a first location may indicate that a failed completion of the transaction is related to an issue associated with the sender, and a placement of the icon in a second location may indicate the failed completion of the transaction is related to an issue associated with a recipient, as illustrated in FIG. 10 and discussed below.

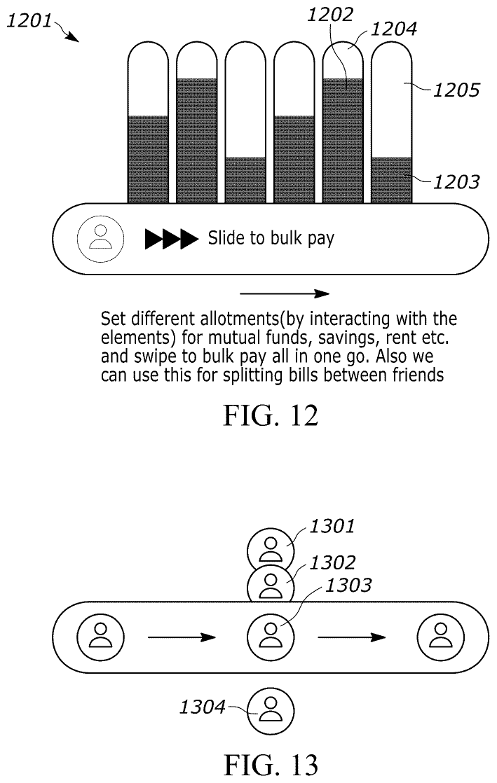

Further, in some examples where the transaction is a payment, the one or more additional elements may include one or more shapes configured to proportionally represent different amounts corresponding to different recipients of a bulk payment, as illustrated in FIGS. 11 and 12 and discussed below. Moreover, in some example, the one or more additional elements may include an interactive element configured to authenticate a user's identity before completing the transaction, as illustrated by FIG. 17 and discussed below. Additionally, in some examples where the transaction is a payment and a user of the user device is a primary user; the one or more additional elements may include one or more interactive elements configured to visually represent additional users, as illustrated by FIG. 13 and discussed below.

The method 200, at block 202, may include detecting, by the user device (e.g., the user computing device 101), an initiation of the user action with respect to the slider element and the one or more additional elements of the graphical display (e.g., as on the graphical display application 115 associated with a transaction as from the transaction application 118). In some examples where the transaction is a payment, the user action may include initiating movement on the first slider element, then stopping at one of the one or more interactive elements representing a fraction of the payment total, and then sliding in a different direction to confirm a partial completion of the transaction, as illustrated in FIG. 18. Moreover, in some examples where the transaction is a payment, the user action may include a first sliding motion on the first interactive slider element and a second sliding motion on the second interactive slider element wherein a final location of the user action on the second interactive slider element corresponds to the tip amount, as illustrated in FIG. 19. Further, in some examples where the transaction is a payment, the user action may include selecting one or more allotments to be included or deducted in the transaction, as illustrated in FIGS. 11 and 12. Additionally, in some examples where the transaction is a payment and a user of the user device is a primary user, the user action may include selecting one or more of additional users to whom to delegate the payment before completing the transaction, as illustrated by FIG. 13.

The method 200, at block 203, may include providing, by the user device (e.g., the user computing device 101), prior to completion of the user action, real-time feedback via the slider element and the one or more additional elements in response to the initiation of the user action of the graphical display (e.g., as on the graphical display application 115 associated with a transaction as from the transaction application 118). In some examples, the real-time feedback may include haptic feedback. For instance, in some examples, the haptic feedback is repeated at a frequency corresponding to the currency denomination multiples before completing the transaction where the transaction is a payment, as illustrated in FIGS. 6 and 7. Moreover, in some examples, the haptic feedback corresponds to a risky status of the transaction before completing the transaction, as illustrated in FIG. 8.

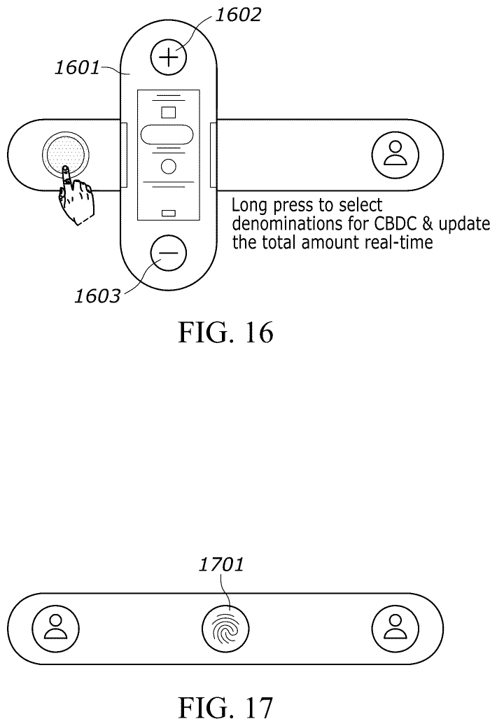

Moreover, in some examples where the transaction is a payment, the real-time feedback may include updating a total payment amount to correspond to a fraction selected by the user action and updating the one or more interactive elements based on the partial completion of the transaction, as illustrated in FIG. 18. Additionally, in some examples where the transaction is a payment, the real-time feedback may include updating a total payment amount with the tip amount and updating the one or more interactive elements based on the partial completion of the transaction before the transaction is completed, as illustrated in FIG. 19. Further. In some examples where the transaction is a payment and the one or more additional elements include an interactive display element configured to visually display one or more currency denominations with increasing or reducing options, the real-time feedback includes updating the total payment amount and updating the one or more interactive elements based on the partial completion of the transaction before completing the transaction, as illustrated by FIG. 16.

Additionally, in some examples where the transaction is a payment, the real-time feedback may include updating a total bulk payment amount and updating the one or more interactive elements based on the partial completion of the transaction before completing the transaction, as illustrated by FIGS. 11 and 12. Further, in some examples where the transaction is a payment and a user of the user device is a primary user, the real-time feedback may include displaying the status of the delegation request based on the response from additional users before the completion of the transaction, and an automatic completion of the transaction after the one or more delegated additional users complete the transaction from their user devices, as illustrated by FIG. 13.

### Example Graphical Displays

FIGS. 3-20 illustrate example graphical user interface displays associated with techniques of this disclosure for providing real-time feedback via one or more elements of a graphical user interface for safer, more informed transactions. For instance, the example graphical user interface displays discussed with respect to FIGS. 3-20 may be generated by the graphical display application 115 and displayed via the user interface 111, and may receive user input via the input/output component 112.

FIG. 3 illustrates an example graphical display associated with a transaction including a conventional single slider 301, for instance, where a single swipe completes a transaction.

FIG. 4 illustrates an example graphical display associated with a transaction that may include an additional element, i.e., in addition to the traditional single slider 301 as shown in FIG. 3. As shown in FIG. 4, this additional element may be a spinner element 401 or 402. The spinner element 401 or 402 may be configured to receive user input including spins at different repetitions across the interactive slider element 403 or 404, and the repetitions of the spins may correspond to frequencies at which a same transaction will be repeated automatically. For instance, spinning the spinner element 401 or 402 once may set up an automatic payment to repeat monthly, whereas spinning the spinner element 401 or 402 twice may set up an automatic payment to repeat yearly.

FIG. 5 illustrates an example graphical display associated with a transaction including a circle 501 or 502, where the size of the circle may correspond to a payment amount, with a larger circle represents higher payment amount in a payment transaction. In particular, circle 501 is smaller and corresponds to a smaller payment amount, whereas circle 502 is larger and corresponds to a higher payment amount. In some examples, the graphical display may be configured such that the larger circle 502 may be “more difficult” to move across the slider element 504 (i.e., to complete the transaction) than the smaller circle 501. That is, the same user input (e.g., a dragging user input to move the circle across the display to complete the transaction) speed may result in a slower movement speed for the larger circle 502 when compared to the smaller circle 501 on the graphical display, to create an effect of “higher friction” and slow down larger payments. Advantageously, this user interface design allows the user more time and draws greater attention of the user to consider the transaction with a bigger payment amount.

FIG. 6 illustrates three examples of geometric shapes which may be included in a graphical display (in addition to, for instance, a slider such as the slider of FIG. 3) associated with a transaction. In some examples, the one or more additional elements may include a geometric shape with number of sides corresponding to currency denomination multiples. In particular, the three sides of the triangle 601 may represent a total of $300, which is three times of $100 currency denomination. Similarly, the six sides of the hexagon 602 may represent $600, and the eight sides of the octogen 603 may represent $800. In some other examples, the number of sides of the geometric shapes may represent fractions of payment amount. For instance, the three sides of triangle 601 may represent ⅓ of the payment. In still other examples, the number of sides of the geometric shapes may represent the number of months for equated monthly installment. That is, for instance, the six sides of the hexagon 602 may represent a 6-month term for an equated monthly installment of equal payments. In each of the examples mentioned above, the different shapes of the additional display element provide additional information to inform the user before completing the transaction. FIG. 7 below illustrates how an additional element in the shape of a hexagon 701 may be incorporated on the interactive slider element 702. In other examples, the triangle 601, or any other geometric shape with a number of sides corresponding to some element of the transaction may be incorporated into a slider element in a similar manner.

FIG. 7 illustrates an example graphical display associated with a transaction incorporating real-time haptic feedback (e.g., provided by an input/output component 1120) in response to user action in a payment transaction. In particular, the haptic feedback may be repeated at a frequency corresponding to the currency denomination multiples before completing the transaction. That is, when the input/output component 112 of the user interface 111 detects an initiation of the user action of sliding the geometric shape element 701, the slider element 702 provides haptic feedback 703 that is generated in intervals that are evenly distributed across the slider element 702 as the user moves the geometric shape 701 across the slider element 702 before the completion of the transaction. For instance, in the example shown at FIG. 7, after a user performs a user action dragging the geometric shape element 701 one-sixth of the way across the slider element 702, the input/output component 112 may generate haptic feedback, and after the user performs a user action dragging the geometric shape element 701 further (i.e., two sixths of the way across the slider element 702), the input/output component 112 may generate haptic feedback, and so forth, until the user has dragged the geometric shape element 701 across the entire slider element 702 and the transaction is completed. That is, as illustrated in FIG. 7, the haptic feedback 703 may be generated six times in intervals evenly distributed across the slider element 702 as the user moves the hexagon shaped element 701 across the slider element 702, corresponding to the payment total of $600 which is six times the predominant currency denominations of $100.

FIG. 8 illustrates an example graphical display associated with a transaction incorporating real-time haptic feedback. In particular, if a recipient of a transaction has a risky status, FIG. 8 illustrates an additional slider element 801 providing haptic feedback 802 as the user action moves across the slider element 803 to warn the user of the risky status of the recipient. Additionally or alternatively, in some examples, the additional element may incorporate bright color to alert the user. Additionally or alternatively, in some examples, the additional element may include a warning message 804. Advantageously, the real-time feedback and additional elements inform the user of potential risk of the transaction and allows the user to reconsider before completing the transaction to the potentially risky recipient.

FIG. 9 illustrates an example graphical display associated with a transaction including one or more distinctive colors to indicate a status of the transaction. As previously discussed above with respect to FIG. 8, the additional element 801 may incorporate bright color to alert the user of a risky status. Similarly, FIG. 9 illustrates an additional element of a first color 901 to represent the successful completion of a payment, and an additional element of a second color 902 to represent the failed completion of a payment. In some examples, the additional element may further include icons to represent the success or failure of payment. FIG. 9 also illustrates that a checkmark icon 903 represents the successful completion of a payment and an exclamation mark 904 represents the failed completion of a payment. The icons may also incorporate distinctive colors.

FIG. 10 illustrates an example graphical display associated with a transaction incorporating various placements of color combinations to indicate more nuanced information to the user. For instance, as FIG. 10 illustrates, a first color, such as red, may indicate a failed transaction, and the placement of the start of the portion 1003 or 1005 in the first color on the slider element 1001 or 1002 may indicate whether the sender or the recipient caused the failure of the transaction. In slider element 1001, the start of the element 1003 in the first color is placed closer to the sender icon 1004, indicating that the failed payment results from the sender, whereas the element 1009 in the second color (such as green) ends further away to the recipient, indicating that the failed payment does not result from the recipient. On the contrary, in slider element 1002, the start of the element 1005 in the first color may be placed closer to the recipient icon 1006, indicating that the failed payment results from the recipient, not from the sender which is further from where the element 1010 in the second color ends. Similarly to examples from FIG. 9, the additional element may further include icons to represent failed payment, as the red exclamation mark icon 1007 or 1008 demonstrates in FIG. 10.

FIG. 11 illustrates an example graphical display associated with a transaction incorporating additional elements in circles of various sizes proportionally to the payment amount each circle represents. In some examples, the additional element of the graphical display may include one or more shapes configured to proportionally represent different amounts corresponding to different recipients of a bulk payment. As used herein, “recipient” may refer to different fund allotments (e.g., mutual funds, savings, rent, etc.) as well as individual recipients (friend, family member, specific bank accounts, etc.) in various examples. In particular, the circle 1101 which represents $200 is smaller than the circle 1102 which represents the $500, and so forth, where the largest circle 1103 represents the largest amount demonstrated in FIG. 11 ($1000). The circles may also denote the specific amounts they represent or the type of funds they represent (not shown in FIG. 11). In other examples, the circles (e.g., 1101-1103) may represent individual recipients including friends or family members and the sizes of the circle may represent the different amounts to different individual recipients.

FIG. 12 illustrates an example graphical display associated with a transaction incorporating additional elements in the form of a bar graph (e.g., 1201), with fillings (e.g., 1202 and 1203) of the bars (e.g., 1204 and 1205) proportionally represent different amounts corresponding to different recipients of a bulk payment. Similarly to the circles in FIG. 11, a higher filling 1204 of the bar 1202 represents a higher payment amount, whereas a lower filling 1205 of the bar 1203 represents a lower payment amount. Moreover, in some examples, the bars may represent individual recipients including friends or family members and the height of the fillings in the bars may represent the different amounts to different individual recipients.

FIG. 13 illustrates an example graphical display associated with a transaction, in which a user of the user device is a primary user, and the additional elements of the graphical display are configured to visually represent one or more additional users 1301-1304. As illustrated in FIG. 13, the primary user may select one or more of the additional users 1301-1304 to delegate the payment in the transaction. After the user selects the additional user(s), the additional user(s) may be notified on the additional user(s)'s user devices and can choose to agree or decline to make the delegated payment. Once the additional user(s) acts on the payment, the user who sent the delegation request will receive real-time feedback including a display of the status of the delegation request and an automatic completion of the transaction.

FIG. 14 illustrates an example graphical display associated with a transaction, including an interactive display element 1401 configured to visually display one or more payment methods. The interactive display element 1401 may be further configured to receive user input indicating a payment option selected by a user before completing the transaction. In some examples, the additional elements of the graphical display on the graphical interface application 115 may be configured to visually display one or more payment methods. For instance, the input/output component 112 may receive user input via the additional element 1401 indicating a payment option selected by a user before completing the transaction, and the user device 101 may complete the transaction using the selected payment option.

FIG. 15 illustrates an example graphical display associated with a transaction that, further including shapes, colors or numbers indicating fund balances of the payment options. As shown in FIG. 15, bar 1501 next to payment option 1502 has a short filling in color red indicating a small amount of available fund in payment option 1502; bar 1503 next to payment option 1504 has a longer filling in color yellow indicating a bigger amount of available fund in payment option 1504; and bar 1505 next to payment option 1506 has the longest filling in color green indicating the biggest amount of available fund in payment option 1506 amongst the three payment options.

FIG. 16 illustrates an example graphical display associated with a transaction including an interactive display element 1601 configured to visually display one or more currency denominations with increasing option 1602 or reducing option 1603. In particular, the additional element 1601 of the graphical display on the graphical interface application 115 may be configured to visually display one or more currency denominations (e.g., Central Bank Digital Currency (CBDC)) with an increasing option 1602 and a reducing option 1603. Advantageously, the currency denominations may inform the user of the currency details, and the increasing option 1602 and decreasing option 1603 are configured to receive user selection to increase or decrease the total payment amount, which is updated and displayed before the completion of the transaction.

FIG. 17 illustrates an example graphical display associated with a transaction including an interactive element 1701 configured to authenticate a user's identity before completing the transaction. In the example illustrated in FIG. 17, the interactive element 1701 is configured to accept fingerprint authentication before completing the transaction. Other forms of authentication including facial recognition or entering credentials may also be incorporated in the interactive element for the purposes of authentication.

FIG. 18 illustrates an example graphical display associated with a transaction including one or more interactive elements 1801-1803 configured to visually represent fractions of a payment total As FIG. 18 illustrates, the additional elements may include icons 1801 and 1802 separating the slider element 1804 evenly into three sections, together with the full payment icon 1803, where each of the icons 1801, 1802 and 1803 represents one third, two thirds and full amount of the total payment, respectively. The additional elements 1801-1803 are configured to detect the user action of sliding on the slider element 1804 until the user action stops at one of the elements and then confirms to make a payment in the amount proportional to the fraction represented by the selected stop. For instance, if the user action stops at icon 1801 which represents the one-third fraction of the total payment, the user action may then swipe upwards or downwards to confirm, which completes a payment transaction with an amount that equals one-third of the total payment amount. In some examples, the action to confirm may also include other actions including pressing down to obtain further confirmation at the stopping point (not shown in FIG. 18).

FIG. 19 illustrates an example graphical display associated with a transaction including a first slider element 1901 and one or more additional elements including a second interactive element 1902 configured to visually represent various options of a tip amount as a part of the transaction. In this instance, the user device 101 may be configured to detect the user action of sliding on the first interactive slider element 1901 and then sliding on the second interactive slider element 1902 to select a tip amount. For instance, if the user action of sliding on the second element 1902 stops at “20% tip” which represents a tip amount that equals 20% of the original total payment amount, the user completes the payment transaction with an updated amount that equals to 120% of the original payment amount where 20% goes to the tips. In some examples, the tip amounts can include other amounts in addition to or instead of the options as shown in FIG. 19.

FIG. 20 illustrates an example graphical display associated with a transaction including a first slider element 2001 and the one or more additional elements including a second interactive slider element 2002 configured to visually represent a voice recording function. In this instance, the voice recording function is configured to receive and store user voice input corresponding to a voice memo associated with the transaction.

Although individual examples in FIGS. 3-20 are illustrated and described as separate examples, in some examples, multiple of the graphical elements discussed above may be combined in the same graphical display. For instance, the payment options as illustrated in FIG. 14 may be combined with the tip amount options as illustrated in FIG. 19, where a user may first select the preferred payment option, and then select the preferred tip amount. Further, for instance, the payment delegation to additional users as illustrated in FIG. 13 may be combined with the voice recording function as illustrated in FIG. 20, where a primary user may first delegate the payment and then record a voice memo associated with the transaction (i.e., recording a reminder to express appreciation to the additional users who accepted the delegated payments). The voice memo may also be transcribed or translated for the receiver's convenience.

### Additional Considerations

The following additional considerations apply to the foregoing discussion and the appended claims. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first set of one or more processors (e.g., in a first computing device) generates X and a distinct, second set of one or more processors (e.g., in a different, second computing device) independently generates Y; (2) implementations in which all processors in the set of one or more processors (e.g., all in the same device, or distributed among multiple devices) contribute to the generation of both X and Y; and (3) other variations.

Unless specifically stated otherwise, discussions in the present disclosure using words such as “processing,” “computing,” “calculating,” “determining,” “presenting,” “displaying,” or the like may refer to actions or processes of a machine (e.g., a computer) that manipulates or trans-forms data represented as physical (e.g., electronic, magnetic, or optical) quantities within one or more memories (e.g., volatile memory, non-volatile memory, or a combination thereof), registers, or other machine components that receive, store, transmit, or display information.

As used in the present disclosure any reference to “one implementation” or “an implementation” means that a particular element, feature, structure, or characteristic described in connection with the implementation is included in at least one implementation or implementation. The appearances of the phrase “in one implementation” in various places in the specification are not necessarily all referring to the same implementation.

As used in the present disclosure, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs through the principles described herein. Thus, while particular implementations and applications have been illustrated and described, it is to be understood that the disclosed implementations are not limited to the precise construction and components disclosed in the present disclosure. Various modifications, changes and variations, which will be apparent to those skilled in the art, may be made in the arrangement, operation and details of the method and apparatus disclosed in the present disclosure without departing from the spirit and scope defined in the appended claims.

What is claimed is:

1. A computer-implemented method for providing real-time feedback via a graphical user interface, the method comprising:
providing, by a user device, a user interface including a graphical display associated with a transaction, wherein the graphical display includes:
(i) an interactive slider element configured to visually represent completing the transaction based on a user action including an interaction with the interactive slider element and (ii) one or more additional elements configured to provide additional user feedback based on the user action;
detecting, by the user device, an initiation of the user action with respect to the slider element and the one or more additional elements of the graphical display; and
providing, by the user device, prior to completion of the user action, real-time feedback via the slider element and the one or more additional elements in response to the initiation of the user action of the graphical display.

2. The computer-implemented method of claim 1, wherein:
the transaction is a payment; and
the one or more additional elements include a second interactive element configured to visually represent a spinner element, wherein:
the spinner element is configured to receive user input including spins at different repetitions, and
the repetitions of the spins correspond to frequencies at which a same transaction will be repeated automatically.

3. The computer-implemented method of claim 1, wherein the real-time feedback includes haptic feedback.

4. The computer-implemented method of claim 3, wherein:
the transaction is a payment;
the one or more additional elements include a geometric shape with number of sides corresponding to currency denomination multiples; and
the haptic feedback is repeated at a frequency corresponding to the currency denomination multiples before completing the transaction.

5. The computer-implemented method of claim 3, wherein:
the transaction is a payment; and
the haptic feedback corresponds to a risky status of the transaction before completing the transaction.

6. The computer-implemented method of claim 1, wherein:
the one or more additional elements include one or more distinctive colors to indicate a status of the transaction, wherein the status may include:
a risky status of a receiver;
a failed transaction; or
an indication of fund balance.

7. The computer-implemented method of claim 1, wherein:
the transaction is a payment; and
the one or more additional elements include a circle wherein:
(i) a size of the circle corresponds to a payment amount wherein a bigger circle represents higher payment amount, and
(ii) wherein for a first payment amount, the user action results in a first movement speed of the circle, and for a second payment amount, greater than the first payment result, a same user action results in a second movement speed of the circle that is less than the first movement speed of the circle,

8. The computer-implemented method of claim 1, wherein:
the transaction is a payment;
the one or more additional elements include one or more interactive elements configured to visually represent fractions of a payment total;
the user action includes:
(i) initiating movement on the first slider element,
(ii) stopping at one of the one or more interactive elements representing a fraction of the payment total, and
(iii) sliding in a different direction to confirm a partial completion of the transaction; and
the real-time feedback includes updating a total payment amount to correspond to a fraction selected by the user action and updating the one or more interactive elements based on the partial completion of the transaction.

9. The computer-implemented method of claim 1, wherein:
the transaction is a payment;
the one or more additional elements include a second interactive element configured to visually represent various options of a tip amount as a part of the transaction;
the user action includes a first sliding motion on the interactive slider element from claim 1 and a second sliding motion on the second interactive slider element wherein a final location of the user action on the second interactive slider element corresponds to the tip amount; and
the real-time feedback includes updating a total payment amount with the tip amount and updating the one or more interactive elements based on the partial completion of the transaction before the transaction is completed.

10. The computer-implemented method of claim 1, wherein:
the transaction is a payment; and
the one or more additional elements include a second interactive element configured to visually represent a voice recording function, wherein the voice recording function is configured to receive and store user voice input corresponding to a voice memo associated with the transaction.

11. The computer-implemented method of claim 1, wherein:
the transaction is a payment;
the one or more additional elements include an interactive display element configured to visually display one or more currency denominations with increasing or reducing options, wherein the display element is configured to receive user input indicating a currency denomination selected by a user to increase or reduce a total payment amount; and
the real-time feedback includes updating the total payment amount and updating the one or more interactive elements based on the partial completion of the transaction before completing the transaction.

12. The computer-implemented method of claim 1, wherein:
the transaction is a payment;
the one or more additional elements include an interactive display element configured to visually display one or more payment methods and to receive user input indicating a payment option selected by a user before completing the transaction, wherein the display element comprises a first portion having a first shape and a second portion having a second shape, and wherein the shape of the first portion relative to the shape of the second portion visually represents fund balance of a first payment method relative to a second payment method.

13. The computer-implemented method of claim 1, wherein the one or more additional elements include corresponding icons, wherein a first icon represents a successful completion of the transaction or a second icon represents a failed completion of the transaction.

14. The computer-implemented method of claim 13, wherein a placement of an icon in a first location indicates that a failed completion of the transaction is related to an issue associated with the sender, and a placement of the icon in a second location indicates the failed completion of the transaction is related to an issue associated with a recipient.

15. The computer-implemented method of claim 1, wherein:
the transaction is a payment;
the one or more additional elements include one or more shapes configured to proportionally represent different amounts corresponding to different recipients of a bulk payment;
the user action includes selecting one or more allotments to be included or deducted in the transaction; and
the real-time feedback includes updating a total bulk payment amount and updating the one or more interactive elements based on the partial completion of the transaction before completing the transaction.

16. The computer-implemented method of claim 1, wherein the one or more additional elements include an interactive element configured to authenticate a user's identity before completing the transaction.

17. The computer-implemented method of claim 1, wherein:
the transaction is a payment;
a user of the user device is a primary user;
the one or more additional elements include one or more interactive elements configured to visually represent additional users;
the user action includes selecting one or more of the additional users to whom to delegate the payment before completing the transaction; and
the real-time feedback includes:
displaying the status of the delegation request based on the response from the additional users before the completion of the transaction, and
an automatic completion of the transaction after the one or more delegated additional users complete the transaction from their user devices.

18. The computer-implemented method of claim 1, wherein the transaction is a file transfer.

19. A system comprising:
one or more processors of a user device; and
at least one memory of the user device storing processor-executable instructions that, when executed by the one or more processors, cause the one or more processors to perform operations comprising:
providing, a user interface including a graphical display associated with a transaction, wherein the graphical display includes:
(i) an interactive slider element configured to visually represent completing the transaction based on a user action including an interaction with the interactive slider element and (ii) one or more additional elements configured to provide additional user feedback based on the user action;
detecting, an initiation of the user action with respect to the slider element and the one or more additional elements of the graphical display; and
providing, prior to the completion of the user action, real-time feedback via the slider element and the one or more additional elements in response to the initiation of the user action of the graphical display.

20. One or more non-transitory computer-readable media storing processor-executable instructions that, when executed by one or more processors of a user device, cause the one or more processors to perform operations comprising:
providing, a user interface including a graphical display associated with a transaction, wherein the graphical display includes:
(i) an interactive slider element configured to visually represent completing the transaction based on a user action including an interaction with the interactive slider element and (ii) one or more additional elements configured to provide additional user feedback based on the user action;
detecting, an initiation of the user action with respect to the slider element and the one or more additional elements of the graphical display; and
providing, prior to the completion of the user action, real-time feedback via the slider element and the one or more additional elements in response to the initiation of the user action of the graphical display.
